(19) United States
(12) Patent Application Publication
(10) Pub. No.: US 2003/0031483 A1
(43) Pub. Date: Feb. 13, 2003

(54) Image forming apparatus

(76) Inventor: Kazuyoshi Kondoh, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/216,302

(22) Filed: Aug. 12, 2002

(30) Foreign Application Priority Data
Aug. 13, 2001 (JP) 2001-245675(JP)

(51) Int. Cl. G03G 15/20

(52) U.S. Cl. 399/313

(57) ABSTRACT

An image forming apparatus of the present invention includes an image transferring device for transferring a toner image from an image carrier to a recording medium and a moving device for selectively moving the image transferring device toward or away from the image carrier. The moving device moves the image transferring device toward the image carrier on the elapse of at least a period of time necessary for the image carrier to rotate from a rotation start position to a reversely rotated position. Assume that a distance between a position where the image transferring device approaches the image carrier and a position where the toner image starts being formed on the image carrier is a, that the image carrier is reversely rotated by a distance of b, that the linear velocity of the image carrier is V, and that a period of time between the start of rotation of the image carrier and image formation is c, then a period of time t necessary for the image transferring device approaches the image carrier after the start of rotation of the image carrier is satisfies a relation of (a+b)/V<t<c.

### BACKGROUND OF THE INVENTION

1. Field of the Invention

The present invention relates to a copier, printer, facsimile apparatus, multifunction apparatus or similar image forming apparatus configured to form a toner image on an image carrier with toner grains having a small size and then transfer the toner image to a sheet or recording medium.

2. Description of the Background Art

It is a common practice with an image forming apparatus to form a latent image on a photoconductive element or image carrier, which may be implemented as a drum or a belt, develop the latent image to thereby produce a corresponding toner image, and transfer the toner image to a sheet by use of image transferring means, which may also be implemented as a belt or a roller. A color copier, for example, includes four developing units each storing one of black toner, cyan toner, magenta toner and yellow toner. The developing devices respectively form a black, a cyan, a magenta and a yellow toner image on associated photoconductive drums. Such toner images of different colors are sequentially transferred to a sheet one above the other by image transferring means, which may be implemented as a belt or a roller, completing a full-color image on the sheet. Subsequently, a fixing unit fixes the full-color image on the sheet.

In the image forming apparatus, when an image transfer clutch is coupled in accordance with the rotation of a main motor, the clutch causes a cam to rotate. Consequently, before toner deposited on the drum in a developing zone passes a nip for image transfer, the belt or the roller for image transfer contacts the drum, so that the toner deposits on the belt or the drum. The toner deposited on the belt or the drum is transferred to the reverse side of a sheet (so-called offset) due to defective cleaning.

A current trend in the image forming apparatus art is toward the use of toner grains and carrier grains having a small size each. Toner grains with a small size enhance the resolution of an image and the reproducibility of thin lines. Also, carrier grains with a small size obtain a greater surface area relative to the carrier grains and thereby allow a toner content to be increased for improving developing efficiency. However, such toner grains and carrier grains bring about the following problems.

When the drum is in a halt or is rotating, the high toner content increases the amount of toner to be transferred from a developing sleeve to the non-image portion of the drum. If an image is formed in such a condition, then the toner is transferred from the drum to the belt or the roller for image transfer at the nip when the belt or the roller is brought into contact with the drum. Although a cleaning blade or cleaning means cleans the surface of the belt or the roller before a sheet arrives at the nip, the former is apt to fail to fully clean the latter when the toner with a small size is left on the belt or the roller in a great amount.

Further, because the timing for causing the belt to contact the drum is based on the rotation of the main motor, the belt contacts the drum before the toner deposited on the drum during the halt or the rotation of the drum passes the nip. As a result, the toner is transferred from the drum to the belt and again brings about offset ascribable to defective cleaning.

Japanese Patent Laid-Open Publication No. 8-297420, for example, discloses a system in which a potential of the same polarity as the toner is applied to the belt in order to promote efficient cleaning. This system, however, has a problem that the belt must make at least one turn before a sheet arrives at the nip in order to electrostatically return the toner deposited on the belt at the nip to the drum, extending a period of time up to the start of image transfer. Another problem is that the toner deposited on the belt cannot be entirely returned to the drum like the toner cannot be transferred from the drum to a sheet with 100% efficiency. Moreover, nip pressure causes part of the toner to be transferred from the drum to the belt in addition to the electrostatic force.

Japanese Patent Laid-Open Publication No. 11-38776, for example, proposes a cleaning device assigned to the belt and including second cleaning means in addition to the cleaning blade or similar cleaning means. The second cleaning means is implemented as a roller or a brush to which a voltage of the same polarity as the toner is applied. The second cleaning means, however, increases the cost of the cleaning means and makes the entire apparatus bulky and sophisticated.

Technologies relating to the present invention are also disclosed in, e.g., Japanese Utility Model Publication No. 7-53091 and Japanese Patent Laid-Open Publication Nos. 9-90778, 2000-47475 and 2000-330327.

### SUMMARY OF THE INVENTION

It is an object of the present invention to provide an image forming apparatus capable of preventing toner from being transferred from an image carrier to the reverse surface of a sheet by way of image transferring means to thereby insure high image quality.

It is another object of the present invention to provide a small size, simple, low cost image forming apparatus.

An image forming apparatus of the present invention includes a rotatable image carrier for forming a toner image thereon, an image transferring device for transferring the toner image to a recording medium, and a moving device for selectively moving the image transferring device toward or away from the image carrier. The moving device moves the image transferring device toward the image carrier on the elapse of at least a period of time necessary for the image carrier to rotate from a rotation start position to a reversely rotated position. Assume that a distance between a position where the image transferring device approaches the image carrier and a position where the toner image starts being formed on the image carrier is a, that the image carrier is reversely rotated by a distance of b, that the linear velocity of the image carrier is V, and that a period of time between the start of rotation of the image carrier and image formation is c, then a period of time t necessary for the image transferring device approaches the image carrier after the start of rotation of the image carrier satisfies a relation of (a+b)/V<t<c

### BRIEF DESCRIPTION OF THE DRAWINGS

The above and other objects, features and advantages of the present invention will become more apparent from the following detailed description taken with the accompanying drawings in which:

FIGS. 1 through 3 are views showing the construction and operation of an image forming apparatus embodying the present invention;

FIGS. 4 and 5 are views showing an alternative embodiment of the present invention; and

FIG. 6 is a timing chart demonstrating the operation of the embodiment shown in FIGS. 4 and 5.

### DESCRIPTION OF THE PREFERRED EMBODIMENTS

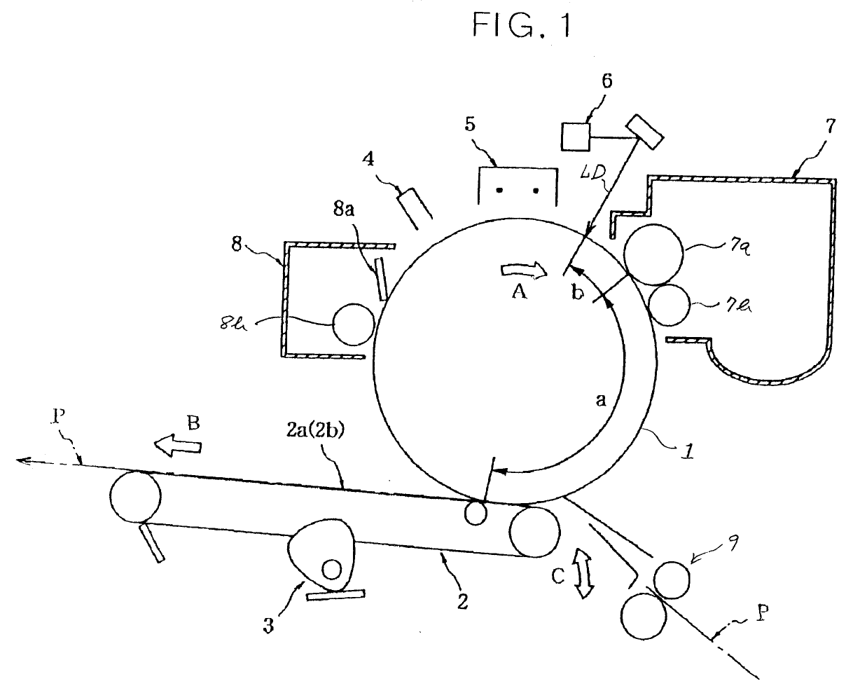

Referring to FIG. 1 of the drawings, an image forming apparatus embodying the present invention is shown. As shown, the image forming apparatus includes a photoconductive drum or image carrier 1 rotatable in a direction indicated by an arrow A. A toner image is formed on the drum 1 by use of a developer made up of carrier grains and toner grains having a small size each. Image transferring means 2 for transferring the toner image to a sheet or recording medium P includes an endless belt 2a movable in a direction indicated by an arrow B. The belt 2a may be replaced with an image transfer roller 2b, not shown, if desired. Moving means 3 selectively moves the belt 2a toward or away from the drum 1 in a direction indicated by an arrow C. The moving means 3 moves the belt 2a toward the drum 1 at least after the drum 1 has rotated by a distance of (a+b), which will be described specifically later. This prevents the toner from being transferred from the drum 1 to the belt 3 and therefore to the reverse surface of the sheet P.

Also arranged around the drum 1 are discharging means 4, charging means 5, latent image forming means 6, developing means 7 including an upper sleeve 7a and a lower sleeve 7b, and cleaning means 8 including a cleaning blade 8a and a cleaning brush 8b. The charging means 5 uniformly charges the surface of the drum 1. After the transfer of the toner image from the drum 1 to the sheet P, the cleaning blade 8a and cleaning brush 8b remove the toner left on the drum 1. Subsequently, the discharging means 4 discharges the cleaned surface of the drum 1 to thereby prepare it for the next image forming cycle. Thereafter, the drum 1 is caused to stop rotating for a moment.

While the drum 1 plays the role of an image carrier in the illustrative embodiment, the image carrier may alternatively be implemented as a photoconductive belt, an intermediate image transfer belt or an intermediate image transfer roller.

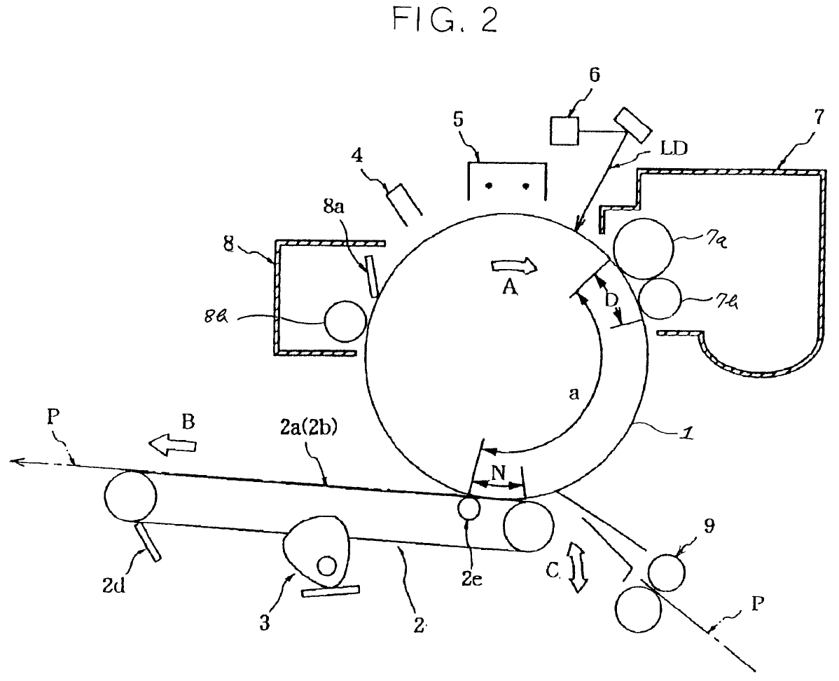

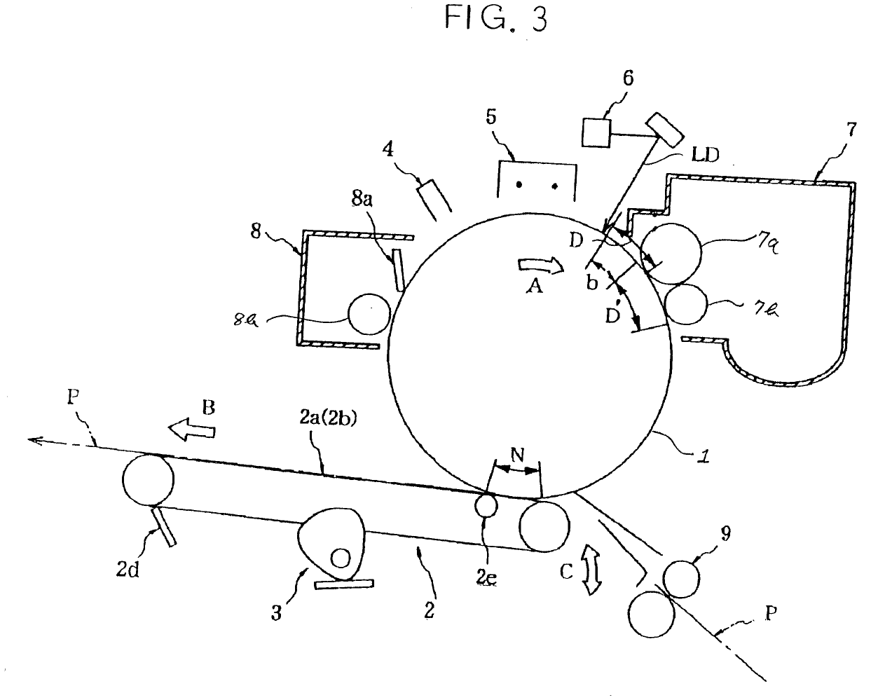

As shown in FIGS. 2 and 3, after the drum 1 has stopped rotating for a moment, the toner grains as well as impurities are transferred to the non-image portion of the drum 1 over a developing zone D facing the sleeves 7a and 7b. At this instant, a distance between a nip N for image transfer and the developing zone D is a, as measured on the drum 1. After the momentary stop of the drum 1, the drum 1 is caused to rotate in the reverse direction by a distance b, so that impurities caught by the cleaning blade 8a are released from the blade 8a. After the reverse rotation of the drum 1, a main motor, not shown, is fully deenergized to end a single image forming job. Likewise, after the start of the next image forming job, the toner grains are transferred to the non-image portion of the drum 1 over a developing zone D′ facing the sleeves 7a and 7b.

The charging means 5 uniformly charges the surface of the drum 1 to negative polarity. The latent image forming means 6 scans the charged surface of the drum 1 with a laser beam in accordance with image data to thereby form a latent image on the drum 1.

In the developing means 7, the developer is deposited on the sleeves 7a and 7b. The toner grains, which are contained in the developer and assumed to be black toner grains, are transferred from the sleeves 7a and 7b to the latent image carried on the drum 1, forming a corresponding toner image.

The sheet P is fed from sheet feeding means, not shown, to a registration roller pair 9. The registration roller pair 9 once stops the sheet P and then conveys it toward the belt 2a at such a timing that the leading edge of the sheet P meets the leading edge of the toner image.

The image transferring means 2 includes a belt cleaner 2d and a bias roller 2e in addition to the belt 2a. After an image forming job, the moving means 3 moves the belt 2a away from the drum 1 just before the main motor stops rotating.

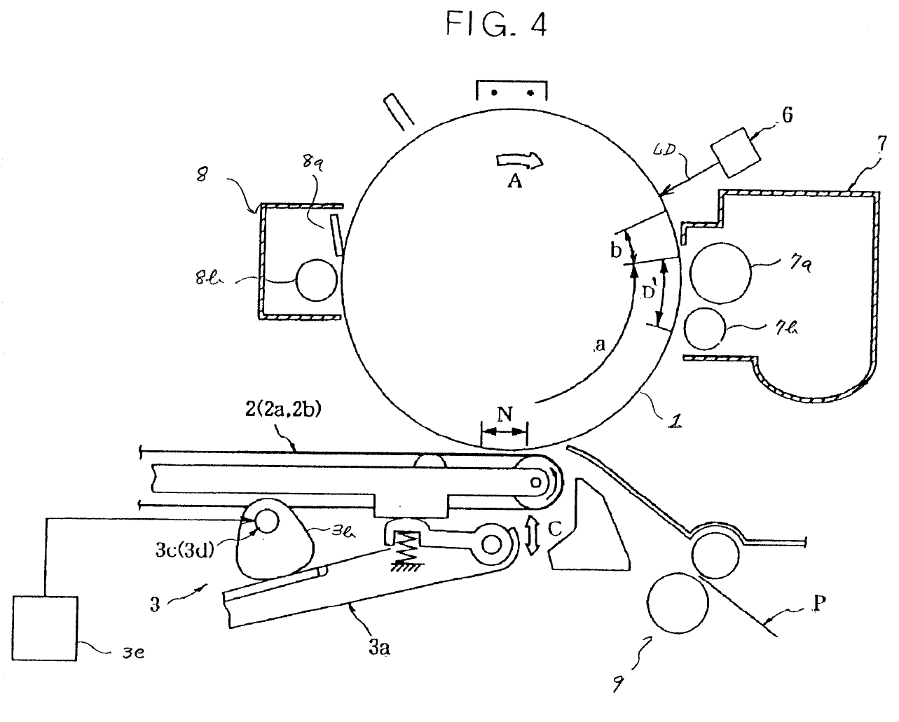

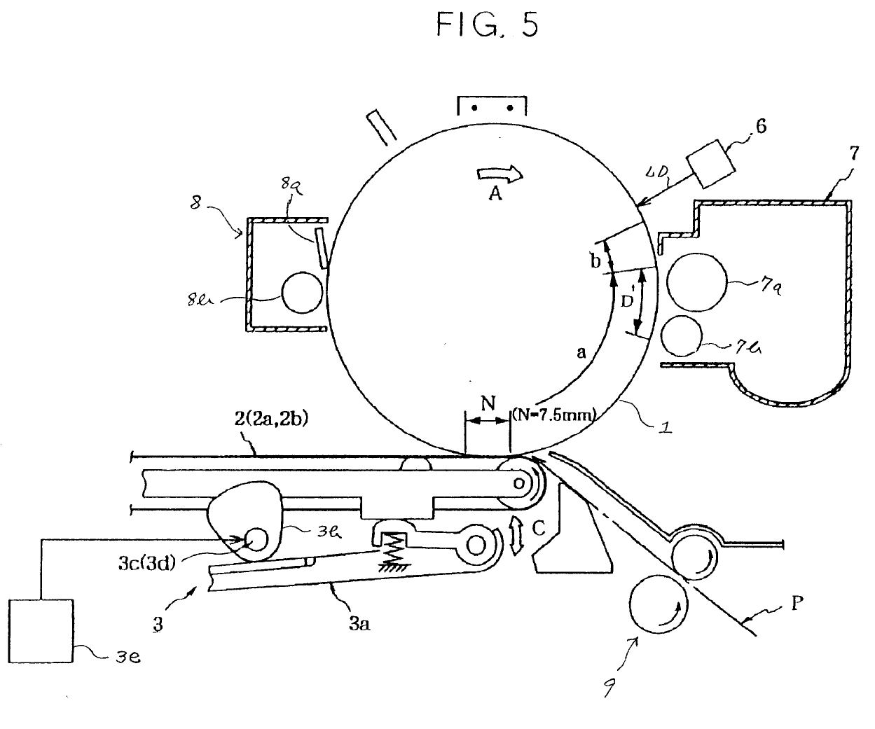

Reference will be made to FIGS. 4, 5 and 6 for describing an alternative embodiment of the present invention. As shown, the illustrative embodiment includes moving means 3 generally made up of a lever 3a, a cam 3b, a half-rotation clutch 3d mounted on a shaft 3c, and a controller 3e. The output torque of the main motor is transferred to the shaft 3c via a gear train not shown. When the half-rotation clutch 3d is coupled, the lever 3a is raised or lowered by the cam 3b in accordance with the profile of the cam 3b. The controller 3e controls the cam 3b such that the belt 2a moves toward or away from the drum 1 on the elapse of a period of time necessary for the drum 1 to rotate from a position where rotation begins, as seen on the drum 1, to a reversely rotated position, but at a position between the rotation start position and a position where a toner image starts being formed.

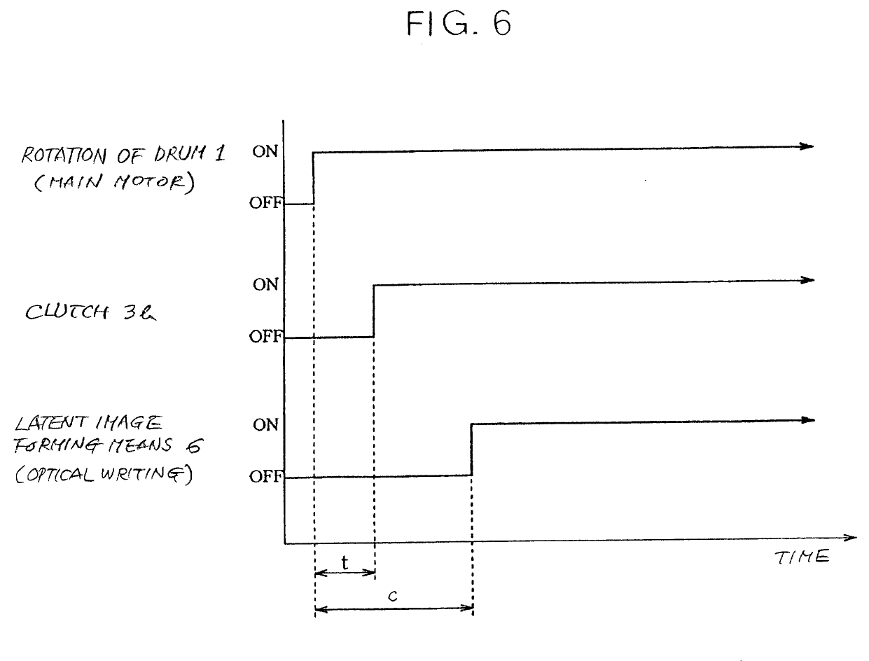

When the belt 2a is brought into contact with the drum 1, it forms the nip N of 7.5 mm More specifically, after the toner on the drum 1 has moved away from the nip N, the belt 2a is brought into contact with the drum 1. This can be done with the following configuration. Assume that the distance a between the nip N and the developing zone D, as measured on the drum 1 is 230 mm, that the distance b by which the drum 1 is reversely rotated is 10 mm, and that the linear velocity V of the drum 1 is 200 mm/sec. Then, as shown in FIG. 6, the clutch 3d is coupled after a period of time of (a+b)/V (=0.7 sec), has elapsed since the start of rotation of the drum 1.

Further, the controller 3e insures stable image quality despite vibration that may occur when the belt 2a approaches or contacts the drum 1 via the sheet P. For this purpose, the controller 3e couples the clutch 3d within a period of time c of 2.3 seconds (see FIG. 6) between the time when the main motor and therefore the drum 1 starts rotating before the latent image forming means 6 starts scanning the drum 1 and the time when the latent image forming means 6 starts scanning the drum 1.

By selecting a relation of (a+b)/V<t<c, it is possible to stably write a latent image on the drum 1 without regard to the vibration stated above. In addition, when the drum 1 is in a halt or is rotating, the toner transferred from the sleeves 7a and 7b to the drum 1 is prevented from being transferred to the belt 2a. This surely obviates the transfer of the toner to the reverse surface of the first sheet P without regard to the cleaning ability. It follows that high image quality is achievable with a small size, simple and low-cost configuration.

In summary, it will be seen that the present invention provides a small size, simple, low cost image forming apparatus capable of obviating the transfer of toner to image transferring means and therefore the offset of a recording medium. Further, high image quality is achievable without regard to vibration ascribable to a shock that may occur when the image transferring means approaches an image carrier.

Various modifications will become possible for those skilled in the art after receiving the teachings of the present disclosure without departing from the scope thereof.

What is claimed is:

1. An image forming apparatus comprising:
a rotatable image carrier for forming a toner image thereon;
image transferring means for transferring the toner image to a recording medium; and
moving means for selectively moving said image transferring means toward or away from said image carrier;
wherein said moving means moves said image transferring means toward said image carrier on the elapse of at least a period of time necessary for said image carrier to rotate from a rotation start position to a reversely rotated position, and
assuming that a distance between a position where said image transferring means approaches said image carrier and a position where the toner image starts being formed on said image carrier is a, that said image carrier is reversely rotated by a distance of b, that a linear velocity of said image carrier is V, and that a period of time between a start of rotation of said image carrier and image formation is c, then a period of time t necessary for said image transferring means approaches said image carrier after the start of rotation of said image carrier is satisfies a relation:
(a+b)/V<t<c

2. The apparatus as claimed in claim 1, wherein the toner image is formed on said image carrier by use of toner gains having a small grain size.

3. The apparatus as claimed in claim 2, wherein the toner is mixed with carrier grains having a small grain size.

4. The apparatus as claimed in claim 3, wherein said image carrier comprises a photoconductive element.

5. The apparatus as claimed in claim 4, wherein said photoconductive element comprises a drum.

6. The apparatus as claimed in claim 4, wherein said photoconductive element comprises a belt.

7. The apparatus as claimed in claim 2, wherein said image carrier comprises an intermediate image transfer body.

8. The apparatus as claimed in claim 7, wherein said intermediate image transfer body comprises a belt.

9. The apparatus as claimed in claim 7, wherein said intermediate image transfer body comprises a roller.

10. The apparatus as claimed in claim 9, wherein said image transferring means comprises an image transfer roller.

11. The apparatus as claimed in claim 2, wherein said image transferring means comprises an image transfer belt.

12. The apparatus as claimed in claim 2, wherein said moving means moves said image transferring means toward said image carrier at a position preceding at least a position, as seen on said image carrier, between a position where said image carrier starts rotating and a position where the toner image is formed on said image carrier.

13. The apparatus as claimed in claim 1, wherein the toner is mixed with carrier grains having a small grain size.

14. The apparatus as claimed in claim 13, wherein said image carrier comprises a photoconductive element.

15. The apparatus as claimed in claim 14, wherein said photoconductive element comprises a drum.

16. The apparatus as claimed in claim 14, wherein said photoconductive element comprises a belt.

17. The apparatus as claimed in claim 13, wherein said image carrier comprises an intermediate image transfer body.

18. The apparatus as claimed in claim 17, wherein said intermediate image transfer body comprises a belt.

19. The apparatus as claimed in claim 17, wherein said intermediate image transfer body comprises a roller.

20. The apparatus as claimed in claim 19, wherein said image transferring means comprises an image transfer roller.

21. The apparatus as claimed in claim 13, wherein said image transferring means comprises an image transfer belt.

22. The apparatus as claimed in claim 13, wherein said moving means moves said image transferring means toward said image carrier at a position preceding at least a position, as seen on said image carrier, between a position where said image carrier starts rotating and a position where the toner image is formed on said image carrier.

23. The apparatus as claimed in claim 1, wherein said image carrier comprises a photoconductive element.

24. The apparatus as claimed in claim 23, wherein said photoconductive element comprises a drum.

25. The apparatus as claimed in claim 23, wherein said photoconductive element comprises a belt.

26. The apparatus as claimed in claim 1, wherein said image carrier comprises an intermediate image transfer body.

27. The apparatus as claimed in claim 26, wherein said intermediate image transfer body comprises a belt.

28. The apparatus as claimed in claim 26, wherein said intermediate image transfer body comprises a roller.

29. The apparatus as claimed in claim 28, wherein said image transferring means comprises an image transfer roller.

30. The apparatus as claimed in claim 26, wherein said image transferring means comprises an image transfer belt.

31. The apparatus as claimed in claim 26, wherein said moving means moves said image transferring means toward said image carrier at a position preceding at least a position, as seen on said image carrier, between a position where said image carrier starts rotating and a position where the toner image is formed on said image carrier.

32. The apparatus as claimed in claim 1, wherein said image transferring means comprises an image transfer roller.

33. The apparatus as claimed in claim 32, wherein said moving means moves said image transferring means toward said image carrier at a position preceding at least a position, as seen on said image carrier, between a position where said image carrier starts rotating and a position where the toner image is formed on said image carrier.

34. The apparatus as claimed in claim 1, wherein said moving means moves said image transferring means toward said image carrier at a position preceding at least a position, as seen on said image carrier, between a position where said image carrier starts rotating and a position where the toner image is formed on said image carrier.
